(19) United States
(12) Patent Application Publication
(10) Pub. No.: US 2007/0113033 A1
(43) Pub. Date: May 17, 2007

(54) APPARATUS AND METHOD FOR CONTROLLING DATA COPY SERVICES

(76) Inventors: Carlos F. Fuente, Portsmouth (GB); William J. Scales, Portchester (GB)

Correspondence Address: Jeffrey P. Aiello;IBM Corporation, 650 Harry Road (L2PB/J2C), San Jose, CA, 95120, US

(21) Appl. No.: 11/466,852

(22) Filed: Aug. 24, 2006

(30) Foreign Application Priority Data
Nov. 16, 2005 (GB) 0523293.9

(51) Int. Cl. G06F 12/16

(52) U.S. Cl. 711/162

(57) ABSTRACT

An apparatus operable with a host and at least first and second data storage for avoiding overwriting of a stored data item in the second data storage by a copy services system is provided. The apparatus includes a storage use analyzer for determining the availability of the second data storage. A copy services requester communicates with the host to receive a request to establish a copy services relationship, using the second data storage as a target data storage. A request blocking and passing component passes the request to establish a copy services relationship using the second data storage as the target data storage, responsive to a positive determination of availability of the second storage. The request blocking and passing component may also block the request responsive to a negative determination of availability of the second data storage.

### BACKGROUND OF THE INVENTION

1. Field of the Invention

The present invention relates to controlling data copy services in data storage systems, and more particularly, to protecting data in data storage systems from the effects of erroneous establishment of copy services relationships.

2. Background Information

The expression “data copy services” refers to the set of services made available in advanced storage systems to provide facilities for allowing either real or virtual copies of data to be made and maintained for various purposes. These purposes may include backup, recovery, and providing “true-to-life” samples of data for the testing of applications, and the like.

Some examples of data copy services are mirroring and point-in-time copying. Mirroring is a well-known technique for improving reliability of disk-based storage subsystems. Peer-to-Peer Remote Copy (PPRC), also known as Remote Copy or Remote Mirroring, is a form of mirroring in which one disk is maintained at a distance from the other, and can be made accessible in the case of a failure of the first. Mirroring provides continuing service in case of a large scope failure. An example of a system that embodies the PPRC principles in their synchronous form, is the IBM® Metro Mirror function.

Point-in-time copying provides a virtual image of the contents of a storage system at a particular point in time. When the point-in-time copy relationship is started, data is not initially physically copied from a source storage to a target storage. Instead, any reads directed to the target storage are transparently satisfied from the source storage. Over a period of time, data may be physically copied from the source to the target as a background activity, and, in addition, any existing data that is to be modified at the source will be transferred to the target prior to the modification taking effect at the source.

Copy service functions, such as FlashCopy® (FlashCopy is a registered trademark of the IBM Corporation, Armonk, NY) or Peer-to-Peer Remote Copy (PPRC) provide the ability to create a copy of an existing volume of data storage. Configuration of these functions in systems such as data storage systems like the SAN Volume Controller®, sold by the IBM Corporation, requires the specification of a target volume to receive the copy of the data.

If the wrong target volume is specified, then a disk that contains valuable data might be misconfigured to act as the target to receive the copy. Unless this error is detected quickly, this can lead to the corruption and loss of the data. Corruption or loss of the data would require recovery from a backup medium.

In certain operating system environments, it is possible to identify that a volume is in use through use of defined protocols. However, in Open Systems environments, which include many those that use SCSI protocols, no such explicit mechanism exists.

Thus, it would be desirable to provide an apparatus and method for protecting data in data storage systems from the effects of erroneous establishment of copy services relationships.

### SUMMARY OF THE INVENTION

An embodiment of the present invention provides an apparatus operable with a host and at least first and second data storage for avoiding overwriting of a stored data item on the second data storage by a copy services system. The apparatus includes a storage monitor for monitoring use of the second data storage and a storage component for retaining one or more use indicators from the storage monitor.

The apparatus also includes a storage use analyzer. The storage use analyzer analyzes the use indicators to make a positive or a negative determination of availability of the second storage.

The invented apparatus further includes a copy services requester. The copy services requester communicates with the host to receive a request to establish a copy services relationship using the second data storage as a target data storage.

A request blocking and passing component is provided for passing the request to establish a copy services relationship using the second data storage as the target. The request blocking and passing component passes the request to the second storage responsive to a positive determination of availability of the second storage. The request blocking and passing component blocks the request responsive to a negative determination of availability of the second storage. Preferably, the request blocking and passing component is further operable to return a request naming a further potential target storage responsive to the negative determination of availability of the second storage.

In an embodiment of the apparatus, the copy services relationship may comprise one of a point-in-time copy relationship, a local mirror copy relationship, and a remote mirror copy relationship. The use indicator may be derived from at least one of an I/O count over time, a volume allow/suppress indicator, a volume reservation indicator, and a SCSI service task performance indicator. In a preferred embodiment, the use indicator is derived from data collected over a configurable time-period.

In a second aspect, the present invention provides a method for avoiding overwriting of a stored data item in a second data storage by a copy services system. The method comprises providing a host and at least a first and a second data storage. Monitoring use of the second data storage. Retaining one or more use indicators from a storage monitor. Analyzing the one or more use indicators to make a positive or a negative determination of availability of the second data storage. Receiving a request to establish a copy services relationship using the second data storage as a target data storage. Passing the request to establish a copy services relationship using the second data storage as the target data storage responsive to a positive determination of availability of the second storage. The method may further comprise the step of blocking the request responsive to a negative determination of availability of the second data storage.

The method may also comprise the step of returning, by the request blocking and passing component, a request naming a further potential target storage responsive to the negative determination of availability of the second storage.

In a third aspect, there is provided a data carrier having functional data thereon, the functional data comprising functional computer data structures to, when loaded into a computer system and operated upon thereby, enable the computer system to perform all the steps of a method according to the second aspect.

In a fourth aspect, there is provided a computer program comprising computer program code to, when loaded into a computer system and executed thereon, cause the computer system to perform all the steps of a method according to the second aspect.

Preferred embodiments of the invention thus contemplate, in their broadest aspect, a technical framework for monitoring which volumes are receiving read or write I/O in a given period of time. If any such volume is designated as the target for a copy service relationship, and has received I/O in the recent period of time, the attempt to configure the copy service relationship is rejected, on the grounds that the disk is in use.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, in which:

FIG. 1 shows in schematic form an apparatus in accordance with a preferred embodiment of the present invention.

FIG. 2 shows in flowchart form one method or one logic arrangement in which a method of operation according to a preferred embodiment of the present invention may be implemented.

### DESCRIPTION OF THE PREFERRED EMBODIMENTS

The following description is provided to enable any person skilled in the art to make and use the invention and sets forth the best modes presently contemplated by the inventors of carrying out the invention. Various modifications, however, will remain readily apparent to those skilled in the art, since the generic principles of the present invention have been defined herein.

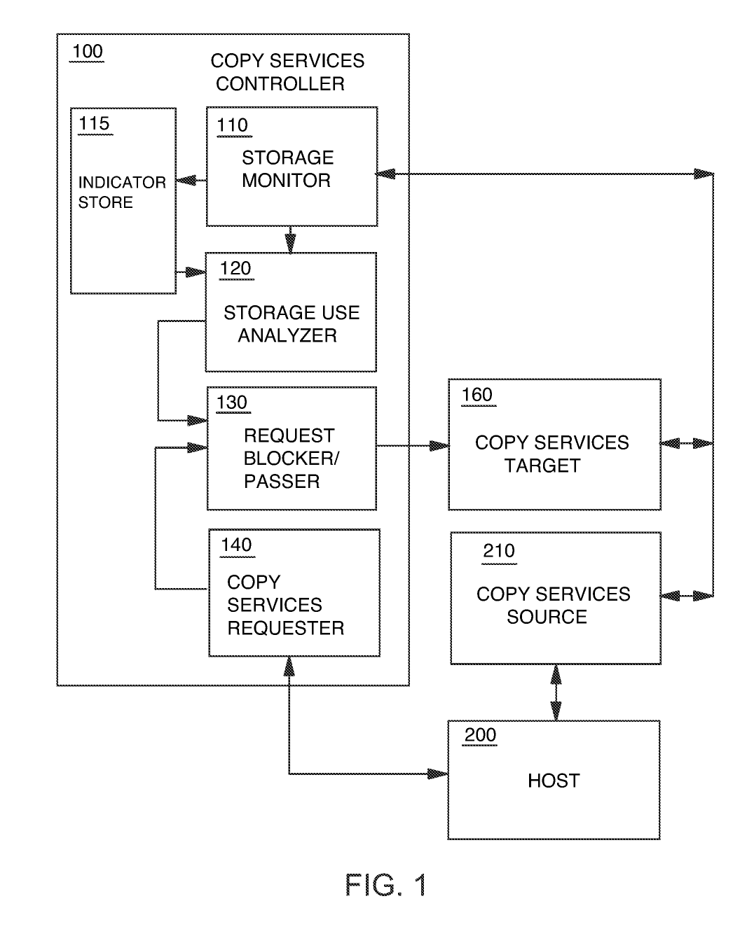

Referring to FIG. 1 of the drawings, there is shown, in schematic form, an apparatus in accordance with a preferred embodiment of the present invention. The invented apparatus includes a copy services controller 100, operatively connected to a host 200 and to a copy services source 210. Copy services controller 100 is also connected in operation with a copy services target 160. Copy services source 210 may comprise a first data storage and copy services target 160 may comprise a second data storage. Each data storage may comprise one or more data storage volumes.

Within copy services controller 100, storage component monitor 110 monitors the use of copy services sources and targets, such as copy services source 210 and copy services target 160. Storage monitor 110 also stores use indicators in indicator storage 115 in order to provide information pertaining to storage use analyzer 120. Storage use analyzer 120 analyzes use indicators from indicator storage 115 to supply analyzed storage use information to request blocker/passer 130.

In operation, host 200 may be instructed by a user, or an application, to establish a copy services relationship using copy services source 210 as the source, for example. The copy services target 160 is a potential target for this relationship. Host 200 requests the establishment of a relationship by copy services controller 100 via copy services requester 140. The copy services requester 140 passes the request to request blocker/passer 130. The request blocker/passer 130 ascertains, from information received from storage use analyzer 120, whether copy services target 160 is in fact available for use as a copy services target for this relationship, based on the analysis of its use that has been recorded.

If copy services target 160 is available for use, blocker/passer 130 passes the request, and copy services controller 100 establishes the copy services relationship. If copy services target 160 is not available for use, request blocker/passer 130 may block the request. If the request blocker/passer 130 blocks a request, it will be clear to one of ordinary skill in the art that various alternative measures are available to a system designer.

For example, a failure may be returned to the host system to allow it to determine an alternative course of action, such as failing back the original request for the relationship to be established. In one alternative, the host system, on receiving a failure indicator, may select an alternative copy services target. In one alternative, the copy services controller 100 may avoid failing the host request and may itself attempt to establish an alternative copy services target to satisfy the request.

In a most preferred embodiment, the copy services controller 100 monitors I/O received by each configured data storage volume. Specifically, the copy services controller 100 monitors I/O received by each configured data volume to determine if any read or write I/O has been received by a volume from any host system in a defined period of time. The defined time period may be 1 minute, for example. This information is used to govern the processing of commands that create new copy services relationships. Any attempt to create a new relationship is rejected if the data storage volume target has received any I/O over the defined time period.

In an alternative embodiment, it may be possible to configure the defined time period that a volume must be idle before considering it safe to be the target of a copy services function. Configuring the defined time period may be advantageous in potentially reducing the number of “false positive” assessments of a data storage volume's “in-use” status in certain circumstances such as when it is known that certain data storage volumes are frequently used for short-lived storage needs and may have accumulated “residual” I/O statistics over a period that may incorrectly indicate that they are not available for use as targets, configuring the defined time period may reduce the number of “false positive” assessments in these data storage volumes.

In another embodiment, selectively applying or suppressing the action of the copy services controller 100 on specified data storage volumes may be applied. Selectively applying or suppressing the actions of the copy services controller 100 may allow for those volumes that are managed by automated scripts. In these instances the scripts are responsible for coordinating host I/O activity with configuration activity, and where a timeout period that would be appropriate for monitoring human user I/O activity would be inappropriate.

Alternative techniques for identifying current host activity, such as identifying the existence of a reservation, a persistent reservation, or an indication of recent processing of other SCSI Tasks, such as Test Unit Ready, are also possible, though the monitoring of host I/O activity is presently the most preferred embodiment.

The preferred embodiment of the present invention in the form of an apparatus thus advantageously addresses the problem of protecting data in data storage from the effects of erroneous establishment of copy services relationships.

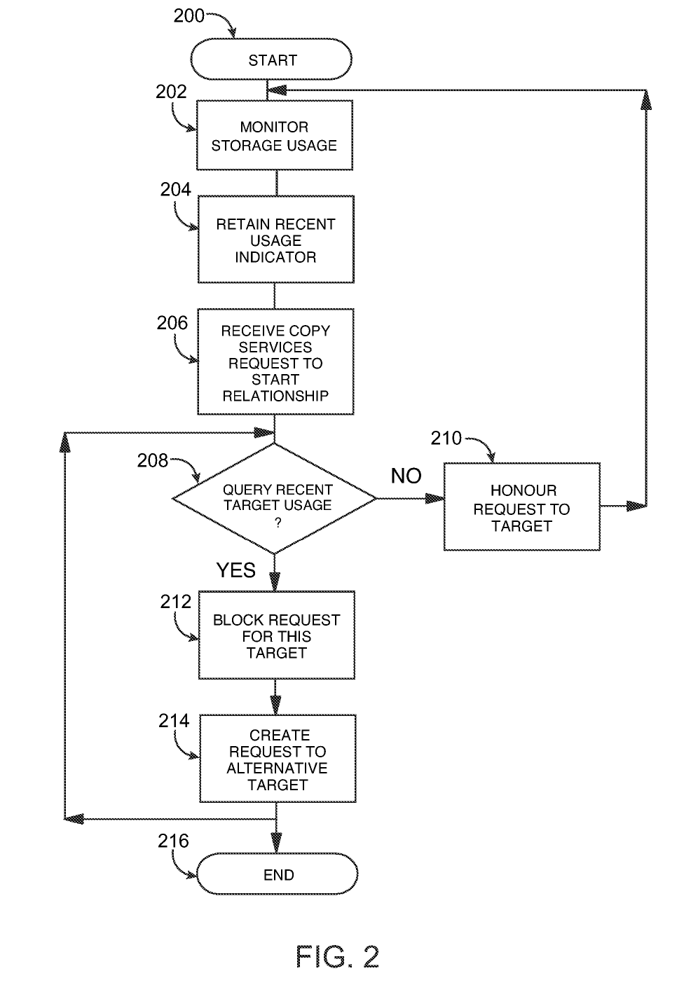

Referring to FIG. 2, there is shown a flowchart of a method, or logic arrangement, of a preferred embodiment of the present invention. The method of the invention commences at START step 200. At step 202 the use of storage data volumes (or any other selected unit, as will be appreciated by one of ordinary skill in the art) is monitored, and at step 204, an indicator of any recent storage use (I/O counts, I/O frequencies over time, or the like) is retained. The retention may take the form of saving to non-volatile storage, for example, on a disk storage device, or it may take the form of saving to volatile storage, such as RAM storage.

Responsive to receipt of a copy services request to start a relationship at step 206 specifying a potential target data storage volume, a query is issued at step 208 to determine the availability of the potential target volume for use as a target of this relationship. If at step 208 the indicator that was retained at step 204 shows no recent target use that would render the potential target volume not available for use as a target volume, the request to start the relationship using that target is honored at step 210. The method or operation of the logic arrangement then returns to monitoring step 202 and continues.

If at step 208 the indicator that was retained at step 204 shows recent target use that would render the potential target volume not available for use as a target, the request to start the relationship using that target is blocked at step 214. In a most preferred embodiment, a request specifying an alternative target is created at step 214, and the process returns to query step 208 for the newly-specified potential target. The method or operation of the logic arrangement concludes at END step 216.

The preferred method of the present invention advantageously addresses the problem of protecting data in data storage from the effects of erroneous establishment of copy services relationships.

It will be clear to one of ordinary skill in the art that all or part of the method of the preferred embodiments of the present invention may suitably and usefully be embodied in a logic apparatus, or a plurality of logic apparatus, comprising logic elements arranged to perform the steps of the method and that such logic elements may comprise hardware components, firmware components or a combination thereof.

It will be equally clear to one of skill in the art that all or part of a logic arrangement according to the preferred embodiments of the present invention may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

It will be appreciated that the method and arrangement described above may also suitably be carried out fully or partially in software running on one or more processors (not shown in the figures), and that the software may be provided in the form of one or more computer program elements carried on any suitable data-carrier (also not shown in the figures) such as a magnetic or optical disk or the like. Channels for the transmission of data may likewise comprise storage media of all descriptions as well as signal-carrying media, such as wired or wireless signal-carrying media.

The present invention may further suitably be embodied as a computer program product for use with a computer system. Such an implementation may comprise a series of computer-readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

In an alternative embodiment, the preferred embodiment of the present invention may be realized in the form of computer implemented method of deploying a service comprising steps of deploying computer program code operable to, when deployed into a computer infrastructure and executed thereon, cause the computer system to perform all the steps of the method.

It will be clear to one skilled in the art that many improvements and modifications can be made to the foregoing exemplary embodiment without departing from the scope and spirit of the present invention.

What is claimed is:

1. An apparatus operable with a host and at least first and second data storage for avoiding overwriting of a stored data item in said second data storage by a copy services system, the apparatus comprising:
a storage use analyzer for determining of availability of said second data storage;
a copy services requester communicating with said host to receive a request to establish a copy services relationship using said second data storage as a target data storage; and
a request blocking and passing component passing said request to establish a copy services relationship responsive to a positive determination of availability of said second storage.

2. The apparatus of claim 1, wherein said request blocking and passing component blocks said request responsive to a negative determination of availability of said second storage.

3. The apparatus of claim 2, wherein said request blocking and passing component returns a request naming a further potential target data storage responsive to said negative determination of availability of said second storage.

4. The apparatus of claim 1 further comprising:
a storage monitor for monitoring use of said second data storage; and
a storage component for retaining one or more use indicators from said storage monitor.

5. The apparatus of claim 1, wherein said copy services relationship comprises a copy services relationship selected from the group consisting of a point-in-time copy relationship, a local mirror copy relationship, and remote mirror copy relationship.

6. The apparatus of claim 4, wherein said use indicator comprises a use indicator selected from the group consisting of an I/O count over time, a volume allow/suppress indicator, a volume reservation indicator, and a SCSI service task performance indicator.

7. The apparatus of claim 4, wherein said use indicator is derived from data collected over a configurable time-period.

8. A method for avoiding overwriting of a stored data item in a second data storage by a copy services system comprising:
providing a host and at least first and second data storage,
analyzing use of said second data storage to make a positive or a negative determination of availability of said second data storage;
receiving a request to establish a copy services relationship using said second data storage as a target data storage; and
passing said request to establish a copy services relationship responsive to a positive determination of availability of said second storage.

9. The method of claim 8 further comprising:
blocking said request responsive to a negative determination of availability of said second data storage.

10. The method of claim 8 further comprising:
returning said request and naming a further potential target data storage responsive to a negative determination of availability of said second data storage.

11. The method claim 8, wherein said copy services relationship comprises a copy services relationship selected from the group consisting of a point-in-time copy relationship, a local mirror copy relationship, and remote mirror copy relationship.

12. The method of claim 8 further comprising the following steps:
monitoring use of said second data storage; and
retaining one or more use indicators from said storage monitor.

13. The method claim 12, wherein said use indicator comprises a use indicator selected from the group consisting of an I/O count over time, a volume allow/suppress indicator, a volume reservation indicator, and a SCSI service task performance indicator.

14. The method claim 12, wherein said use indicator is derived from data collected over a configurable time-period.

15. An apparatus operable with a host and at least first and second data storage for avoiding overwriting of a stored data item in said second data storage by a copy services system, the apparatus comprising:
a storage monitor for monitoring use of said second data storage;
a storage component for retaining one or more use indicators from said storage monitor;
a storage use analyzer for analyzing said one or more use indicators to make a positive or a negative determination of availability of said second storage;
a copy services requester communicating with said host to receive a request to establish a copy services relationship using said second data storage as target; and
a request blocking and passing component, the request blocking and passing component passing said request to establish a copy services relationship responsive to a positive determination of availability of said second storage and blocking request responsive to a negative determination of availability of said second storage.

16. The apparatus of claim 15, wherein said request blocking and passing component returns a request naming a further potential target data storage responsive to said negative determination of availability of said second storage.
